(19) United States
(12) Patent Application Publication
(10) Pub. No.: US 2002/0020454 A1
(43) Pub. Date: Feb. 21, 2002

(54) Device to control the behavior of a metal casing containing spontaneously inflammable material in the event of external fire

(75) Inventor: Olivier Dassis, St Hilaire St Hesmin (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: PROTAC, LA FERTE SAINT AUBIN (FR)

(21) Appl. No.: 09/893,665

(22) Filed: Jun. 29, 2001

(30) Foreign Application Priority Data
Jun. 30, 2000 (FR) 00 08517

(51) Int. Cl. F16L 55/16

(52) U.S. Cl. 138/98

(57) ABSTRACT

To prevent the sudden explosion of a casing containing a combustible material such as propergol in the event of fire in the vicinity, with the violent outburst of big splinters, the invention provides for relatively embrittled zones in the casing, in the form of holes plugged by plugs made of a material that melts more easily than the material of the casing.

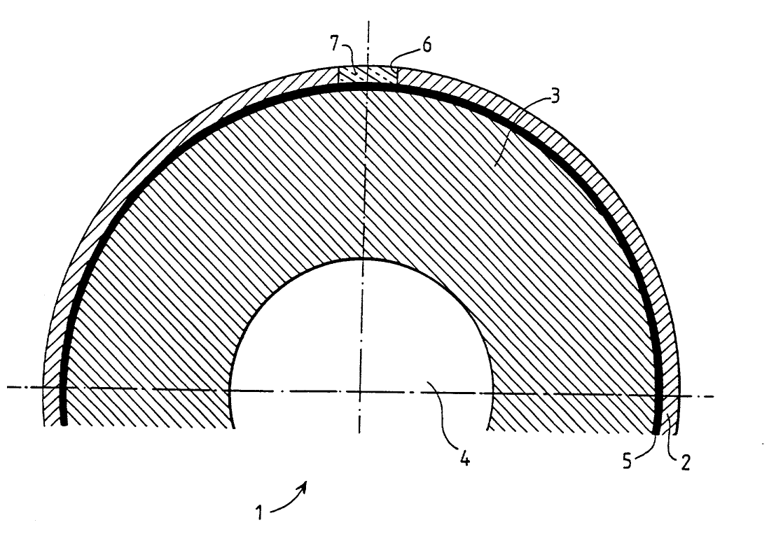

### BACKGROUND OF THE INVENTION

The present invention pertains to a device for controlling the behavior of a metal casing containing spontaneously inflammable material in the event of external fire.

Certain missile thrusters have a metal structure and react violently when subjected to heating because of surrounding fire. In this case, a large number of significantly sized splinters of the metal structure are violently thrown out over long distances. This reaction results from the combination of two phenomena:

whatever the architecture of the thruster, the heating due to the fire prompts a pyrotechnic reaction on the part of the thrusters. The energy thus released prompts a rise in pressure in the casing of the thruster;

simultaneously, the properties of mechanical resistance of the casing are not sufficiently weakened by the fire. The casing breaks at high pressure, giving rise to big metal splinters.

### SUMMARY OF THE INVENTION

An object of the present invention is a device to control the behavior of a metal casing containing spontaneously inflammable material, in the event of external fire, without any risk of violent outbursts of large splinters of the casing, this device being easily adaptable to different sorts of casings while being inexpensive and efficient in almost every instance.

The device according to the invention comprises at least one embrittled zone, in the wall of the casing, that does not degrade the mechanical qualities of the casing in normal conditions of operation.

### BRIEF DESCRIPTION OF THE DRAWINGS

The present invention will be understood more clearly from the following detailed description of an embodiment given by way of a non-restrictive example and illustrated by the appended drawing, wherein the single figure is a partial sectional view of a missile thruster provided with a device according to the invention.

### MORE DETAILED DESCRIPTION

The present invention is described here below with reference to a missile thruster that undergoes an accidental fire in its storage hangar, but it is clearly not limited to this single application and can be implemented in other applications comprising a metal casing, already pressurized internally, or else containing products that can place it under normal pressure, or under overpressure in the event of accidents, this overpressure prompting the explosion of the casing with violent outbursts of splinters from this casing.

According to the invention, one or (preferably) more embrittled zones are made in the casing 3. These are zones which, in normal times (when there is no fire in the vicinity), do not degrade the mechanical qualities of the casing. In other words, the behaviour of the thruster in normal operation (when propelling a missile for example) is not thereby modified. In the embodiment shown in the drawing, each of these embrittled zones has a small-diameter hole 6. For a casing with a diameter of about 160 mm, the number of these holes is about five, and they are evenly distributed throughout the peripheral surface of the casing. Each of these holes, as shown in the drawing, may be a via hole, plugged by a plug 7 force-fitted into the hole and capable of being ejected when the internal pressure goes beyond a specified threshold. This plug may be made of a meltable material with a melting temperature appreciably below the melting temperature of the material of the casing 2. This meltable material may be tin for example. According to another embodiment (not shown), the holes are blind holes (countersunk holes) made from outside the casing, or else they are rectilinear, polygonal or circular notches made on the external peripheral face of the casing, with a depth smaller then the thickness of the casing.

When the casing of the invention is subjected to external fire, the heating of its wall 2 prompts the spontaneous inflammation of the propergol 3. The gases generated by this inflammation cause the pressure inside the casing to rise. When this pressure starts rising, the plugs 7 of the holes 6 are ejected (or melt under the effect of the heat if they are made of a material that melts at this temperature). The hot combustion gases, in escaping through the holes thus opened up, heat the edges of these holes, thus enlarging them and providing for a faster discharging of the gases. In the extreme case where the combustion of propergol might diverge by ignition in the central channel, the sudden increase in the bursting pressure of the casing would be limited. Indeed, the properties of mechanical resistance of the casing are degraded by the presence of the holes or notches of the invention and the increased pressure in the central channel is transmitted to be casing, whose embrittled zones ultimately yield before the pressure reaches the value that it would have had in the absence of these embrittled zones.

Advantageously, the casing may be lined with heat-insulating material (paint or a layer of insulating material) in order to adapt the behaviour of the embrittled zones to the progress of the temperature in the casing, by delaying this rise in temperature.

What is claimed is:

1. A device to control the behavior of a metal casing, containing spontaneously inflammable material, in the event of external fire, the device comprising at least one embrittled zone, in the wall of the casing, that does not degrade the mechanical qualities of the casing in normal conditions of operation.

2. A device according to claim 1, wherein each embrittled zone comprises a hole plugged by a material less resistant than the material of the casing.

3. A device according to claim 2, wherein the plugging material has a melting temperature below that of the material of the casing.

4. A device according to claim 2 or 3, wherein the plugging material is force-fitted into the corresponding hole and can be ejected therefrom for an internal pressure substantially below the pressure prompting the bursting of the casing.

5. A device according to claim 1, wherein each embrittled zone has grooves or notches made in the casing.

6. A device according to one of the above claims, wherein the casing is coated with a heat-insulating material.
